(19) United States
(12) Patent Application Publication
(10) Pub. No.: US 2026/0166558 A1
(43) Pub. Date: Jun. 18, 2026

(54) Process for More Efficient Spheroidisation of High-Quality Graphite Particles

(71) Applicant: NETZSCH Trockenmahltechnik GmbH, Selb (DE)

(72) Inventors: Patrick Schöbel, Frankfurt am Main (DE); Frank Winter, Mühlheim (DE); Christian Höfels, Hanau (DE)

(21) Appl. No.: 19/410,004

(22) Filed: Dec. 5, 2025

(30) Foreign Application Priority Data
Dec. 5, 2024 (DE) 10 2024 136 388.6

(51) Int. Cl. B02C 7/17; B02C 23/08; C01B 32/21

(52) U.S. Cl. CPC B02C 7/17; B02C 23/08; C01B 32/21; C01P 2004/32

(57) ABSTRACT

A device for rounding a graphite material by collision force, including a processing chamber, a feeder device for introducing graphite material into the processing chamber, and a number of rounding tools, which—preferably—are arranged on the outer circumference of a rotor, preferably in the form of a disk, rotating about a rotation axis and in a rotation direction, that is situated in the processing chamber, wherein the rounding tools are configured in such a way that they can act upon graphite particles during operation so that the latter become rounded by folding, with a separation device for extracting fine material and superfine material as well as a product outlet, wherein the processing chamber is equipped with a coolant feeder device through which the free coolant can be introduced into the processing chamber, wherein the device preferably also includes a regulator for the processing chamber temperature.

### TECHNICAL FIELD

The invention relates to a process for more efficient rounding or spheroidization of high-quality graphite particles.

### BACKGROUND

Lithium-ion batteries are the state of the art at present, with accumulators being used to power electric devices—from the laptop, to hand tools and even automobiles.

It is standard practice in current technology to equip lithium-ion batteries with a graphite anode. The graphite anode has, first, the task of conducting electric current and conveying it externally, a use for which graphite is most suited by its nature. In addition, with each use of electric current, Li ions flow from the accumulator cell to the anode by way of its electrolytes and have to be stored in its lattice structure.

Along with its chemical purity, graphite's morphology plays a decisive role.

For use as an anode material, spherical graphite (SG) proves ideal. Its smooth surface, clearly less anisotropic and therefore receptive in all respects, is capable of interacting effectively with the Li ions that are to be stored in the anode material and thereby to offer high anode chargeability. In addition, spherical graphite is less prone to flaking and its associated irreversible loss of capacity, and thus a longer useful life is attainable. Altogether, use of spherical graphite assures higher energy density paired with greater endurance.

Graphite occurs in nature, among other forms, distributed in stone as so-called flake graphite, as illustrated in FIG. 2a. Untreated flake graphite with its layered morphology shows distinctive basal planes. Those are the planes structured parallel to the crystalline structure of graphite. Along these planes, graphite constitutes an excellent thermal as well as electric conductor, whereas graphite perpendicular to the basal planes—that is, between the individual planes—can be considered a thermal as well as electric isolator. Thus, flake graphite shows a pronounced anisotropy.

For this reason, flake graphite must be processed to convert it into the required spherical graphite. The basal problem is largely irrelevant to that material. It lends itself far better to electrical applications. FIG. 2b conveys an impression of the appearance of spheroidized graphite material with the particle size, or degree of fineness, of SG 20.

Other grades of fineness often demanded in practice include SG 22, 18, and 10. As a specialist in the field knows, reference can be made to fineness grade SG 22 when the d₅₀ of the material reaches 22 μm, that is, 50% of the particles making up the graphite material have an equivalence diameter less than or equal to 22 μm, based on the particle volume. This also applies analogously to other degrees of fineness.

The corresponding preparation process is familiar in the art, although it is still based on a fairly new technology. It is called spheroidization.

Spheroidization is not achieved by grinding or circular milling of individual particles of the flake graphite, but rather by so-called multiple folding of the graphite flakes. Folding is achieved by allowing graphite flakes borne by a carrier gas stream or process gas stream to collide repeatedly with obstacles at a kinetic energy that is selected in such a way that the graphite particles are not fractured but only folded, meaning reshaped.

In this process, as a rule, the raw graphite is initially subjected to a true grinding process in a classifier mill to pre-reduce it and generate graphite flakes that are small enough to be able to produce spherical graphite of the desired quality or degree of fineness in a subsequent spheroidization step. For this purpose, the graphite material ground in this manner is introduced in stages into a so-called spheronizer or graphite-rounding machine.

This device is equipped with built-in components that subject the graphite particles to multiple folding and thereby spheroidize it, rather than unnecessarily crushing it further. Such a spheronizer generates a strong turbulent airstream within the installation. This necessarily involves the passage of an externally generated process gas stream, but the process gas stream here is smaller than in a comparable mill. After a certain period of processing, the desired product quality is achieved. The spheronizer is now unloaded. The obtained graphite mixture is introduced into an integrated or external sifter, which separates the finished spherical graphite particles from the resulting disposable ground product.

A spheronizer is most effective at rounding if low air quantities flow through the device. Because, in the process of spheroidizing, considerable mechanical energy is introduced into the process space of the spheronizer, the temperature in the spheronizer rises strongly during rounding of a batch. This occurs because the still-minor quantities of air that pass through the spheronizer during spheroidization, and the quantitatively limited withdrawal required for the intended rounding into fine graphite material, are incapable of producing an effective cooling process. Temperatures above 100° C. are thus the rule. This poses a problem, first of all, for systems engineering. Rapidly turning components can be built which are intended to connect as seamlessly as possible with the existing housing parts. That alone, given the severe temperature fluctuations arising from the variable impact profile of spheroidization, can lead to problems.

To deal with this difficulty, the prior art has foreseen ways to cool highly impacted processing components by means of a closed cool water circulation process.

Even if the site of the spheronizer and other temperature-sensitive components is cooled in the aforementioned ways and means, one problem persists. The various temperatures throughout this batch lead to constantly changing gap sizes. These are challenging for consistent product quality because the air quantities in each processing batch continue to fluctuate. In the current state of the art, attempts are made to solve this problem by also connecting the housing of the milling space and/or the grinding tools with the closed cool water circulation.

This type of cooling, however, has not proved thoroughly satisfactory so far. In part, the housing surfaces of the processing chamber of the respective spheronizer are too limited in area to assure truly effective cooling. This is especially problematic with expanding structural sizes of spheronizers, since the housing surface increases less strongly in proportion to the energy applied to the processing chamber as a result of the greater building size. In numerous cases, familiar housing cooling processes are also too sluggish to allow optimal processing, as reflected in corresponding product quality.

### SUMMARY

The invention is based on the problem of providing a device and a process for spheroidization in which the temperature in the installation can be better controlled.

According to the invention, this problem is resolved by a device in accordance with the claims.

The inventive device is also designated as a spheronizer. This type of structure is a device for rounding a graphite material by collision force.

The inventive device includes a processing chamber and a feeder device or access for introducing graphite material into the processing chamber.

The inventive device further includes a number of rounding tools. These are—preferably—disposed preferably on the outer periphery of a rotor rotating about a rotary axis and in a rotary direction, which is situated in the processing chamber.

The rotor is preferably configured in the form of a disk.

In this process the rounding tools are configured so that during operation they can act on the graphic particles found in the processing room in such a way that the particles—at least, the majority of them—are rounded by folding. The inventive device is thus distinguished in its design specifically in that it does not act primarily by fracturing and/or abrading the graphite material that is to be treated as a means of achieving the required rounding, but rather acts mainly by reshaping.

In addition, and as a rule completely physically separate from the aforementioned rotor, the inventive device has a separation device for removing fine material and superfine material from the processing space.

Finally, the inventive device possesses a product outlet.

From considerations of patent law, it should be pointed out, first, that pure air, pure graphite or a mixture of air and graphite do not constitute cooling agents under the terms of the invention. Instead, use is made in most cases of a coolant produced from a carrier gas and a liquid for this purpose.

The coolant is employed as a free cooling agent; that is, it does not flow through the processing chamber in a closed channel inside which the cooling agent absorbs heat in the manner of a heat exchange, but instead it is conveyed into the processing chamber in such a way that it mixes there with the graphite that is to be rounded.

Advantageously, the inventive device, in addition, is equipped with at least one guide apparatus and usually also comprises a covering ring, which is typically installed above the rounding tools.

Because the cooling agent is introduced into the processing chamber as a free cooling agent, it can mix together in the processing chamber with the graphite material that is to be rounded and therefore can, in particularly intensive and rapid manner, absorb at least part of the energy introduced into the material that is to be rounded, convert it (e.g., by coolant steaming) and/or transport it away, e.g. by extracting the coolant by the separation device and the energy received from it. In this manner the processing chamber—essentially independently of the configuration of said processing chamber and of the installation size—can be cooled more effectively than previously.

Because of the essentially fewer reaction delays of the cooling system in comparison with a mere housing cooling of the processing chamber, regulation (in the sense of a closed loop control) of the cooling space temperature can also be achieved more effectively than before.

Because, owing to the inventive cooling, it is possible to reduce the temperature range which occurs in the course of processing a single batch, the batch processing can occur not only more rapidly (since, in bringing energy by the rounding tools, less attention must be paid to the amount of the energy input) but also it increases the rounding quality. In many cases the batch size can also be increased because the higher energy input, which is necessary for processing a greater batch in the same time, no longer drives the temperature to inadmissible levels.

Particularly preferably, the cool feeder device includes at least one coolant atomizer. Such a device atomizes the coolant before and/or while it arrives in the processing chamber. The ideal choice has proved to be the use of cooling-liquid and in particular a water atomizer, usually of distilled or demineralized water, in order to leave no residue and in particular no lime crystals in the graphite. Ideally, the treatment must avoid any soaking or strong dampening of the graphite particles that is strong enough to risk causing clumping effects in the graphic particles. Instead, it is essential to avoid modifying any residual dampness of the graphic particles during the batch processing, at least to any serious extent.

Particularly preferably, the cool feeder device includes at least one coolant atomizer. Such a device atomizes the coolant before and/or while it arrives in the processing chamber. The ideal choice has proved to be the use of cooling-liquid and in particular a water atomizer, usually of distilled or demineralized water, in order to leave no residue and in particular no lime crystals in the graphite. Ideally, the treatment must avoid any soaking or strong dampening of the graphite particles that is strong enough to risk causing clumping effects in the graphic particles. Instead, it is essential to avoid modifying any residual dampness of the graphic particles during the batch processing, at least to any serious extent.

One particularly favorable option has proved to be configuring the coolant feeder device so that it includes at least one, and preferably several dual fluid nozzles. Such a dual fluid nozzle can, for instance, be fed with coolant liquid, particularly water, and at the same time with air. It can then generate water mist—as a rule, situated above the dew point from the beginning—whose drops completely turn to steam if they combine in the processing chamber with the heated graphite particles to form a graphite-air-aerosol mixture. In the process they withdraw energy from the content of the processing room by their vaporization enthalpy, particularly more energy (nine to ten times more) than by simply heating up a liquid without phase alteration, which for instance would be present in the event of housing cooling.

Ideally, the processing chamber is closed off by a cover, preferably by a top cover, with the coolant feeder device penetrating the cover so that a port is configured by which the coolant is issued through the cover into the processing chamber. Experience has shown that a coolant feeder from above, that is through the cover, is most effective because in this manner streaming conditions in the processing chamber can be best made use of.

Here it is most ideal if the coolant feeder device protrudes freely into the processing chamber through the support container surrounding it, but preferably by less than 5 mm. This arrangement can avoid the danger, even in the use of coolant mist, that the freshly emerging vapor soaks the housing, cover or compartment surface and remains suspended on it as a film rather than being vaporized directly.

In many cases it is particularly favorable that the coolant is introduced into the processing chamber with an overpressure of at least one bar. Thus, it can shoot into the processing chamber and mix particularly quickly and intensively with the turbulent activated graphite-air aerosol of the grinding space. The water and vapor pressure in the dual liquid nozzle influences the droplet size in the spray mist. Especially preferable are small droplets in order to offer contact with the greatest surface area possible. The impact in spheroidization leads to a strong heating of the individual particles with short-term temperature peaks which are clearly above the gas temperature inside the spheronizer Accordingly, rapid vaporization with sufficiently small droplet size and good atomization is assured.

It is favorable in many cases if the coolant departs the processing chamber by way of the separation device, at least in part, but preferably for the most part or even almost entirely.

Most favorably, the device should have at least one indicator for the processing chamber temperature, and this instrument should preferably be situated one-half a processing chamber nominal diameter's distance from the circuit of the at least one coolant feeder device. In this manner it is possible to prevent the indicator from being immediately contacted by a coolant surge or coolant current as soon as it is introduced into the processing chamber, which would mistakenly cause the recording of a lower temperature than the actual temperature relevant in the processing chamber.

It is particularly preferable for the temperature reading device to be positioned in the cover and ideally, at least essentially, to have the same radius as the coolant feeder device—thus preferably displaced at an angle of 90° to 270° to the coolant feeder device.

Additional applications, configuration options, modes of operation and advantages of the invention can be observed from the embodiment and the comments to be found below under the descriptions.

### BRIEF DESCRIPTION OF THE DRAWINGS

The drawings are as follows:

FIG. 1 shows the spheronizer in a sectional view (medium longitudinal section). FIG. 1A shows an enlarged detailed view from FIG. 1.

FIG. 1B shows the spheronizer according to FIG. 1 in an overhead view, in which the two inventive ports 5a, 5b for the coolant application and temperature indication in the spheronizer can now also be recognized.

FIG. 1C shows a view into the spheronizer according to FIG. 1B from below (with underside vertical to the main rotation axis cut away).

FIG. 2A shows untreated flake graphite.

FIG. 2B shows spheroidized graphite material of the fineness grade SP 22.

FIGS. 2C through 2E show additional product results.

### DETAILED DESCRIPTION

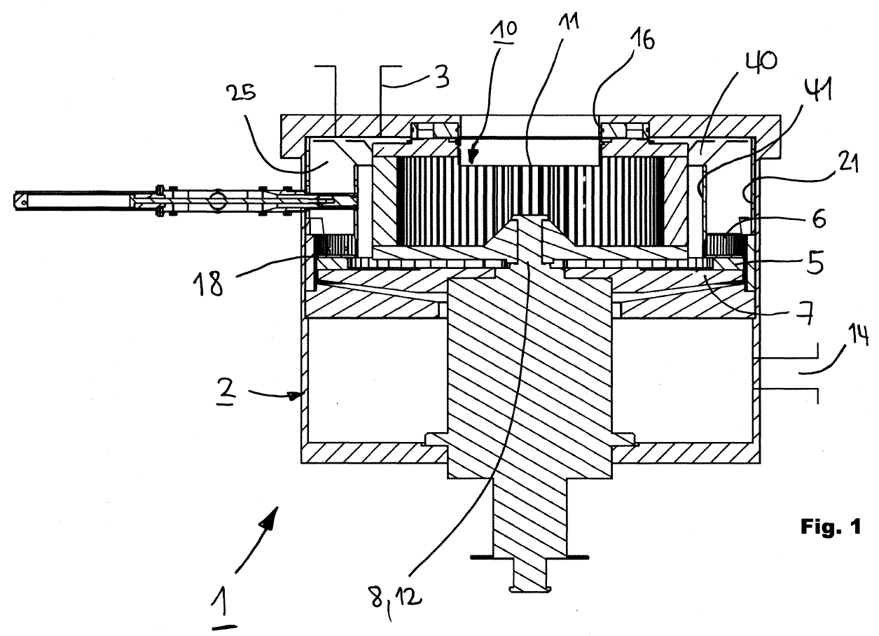

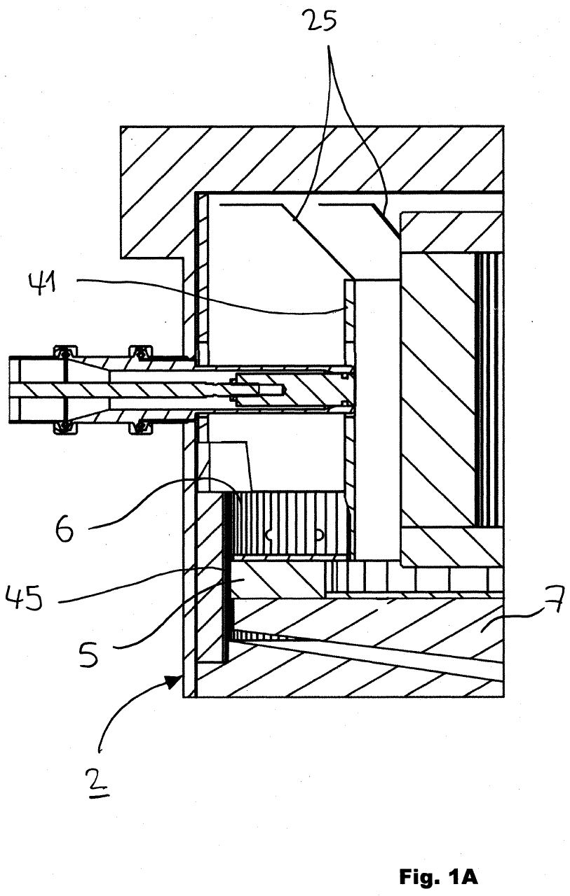

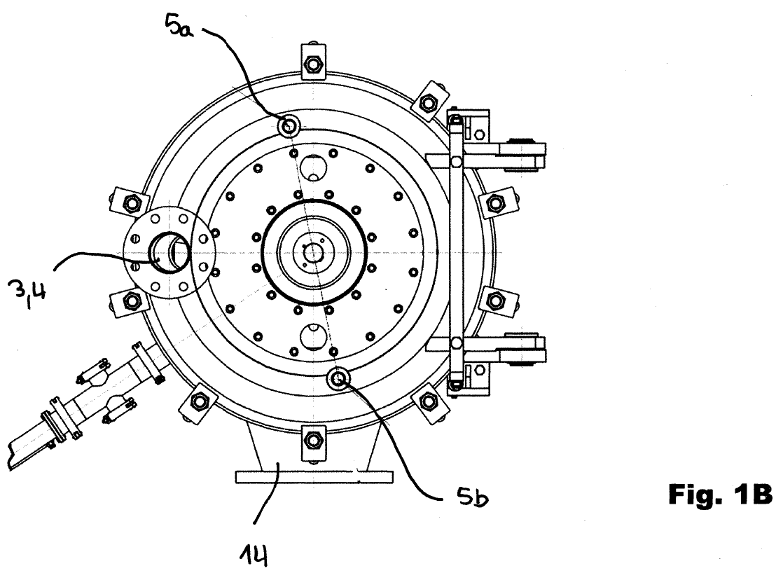

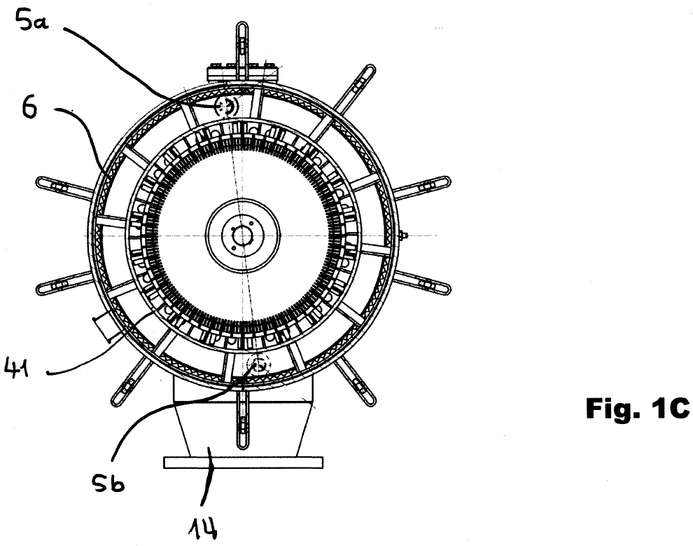

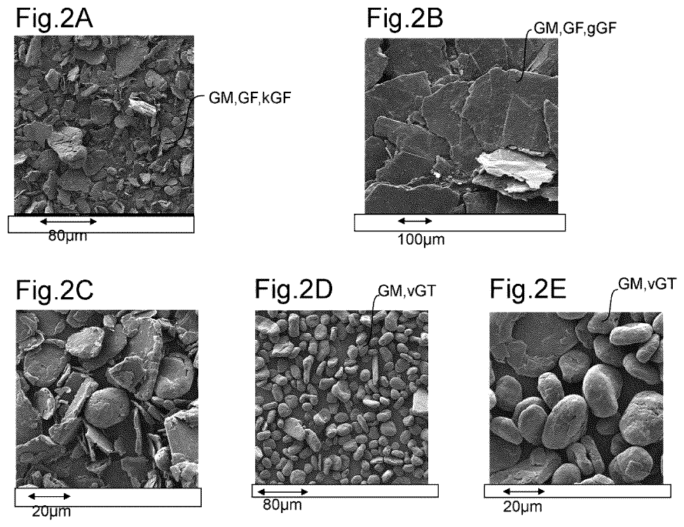

FIG. 1 shows an inventive device 1, which is also referred to as a spheronizer and serves for the rounding of graphite flakes GF of a graphite material DM or even for the rounding of its prior stage, such as unprocessed raw material for instance, which is not especially emphasized in each case below—since in fact the present schematic view omits elements such as the coolant feeder or the temperature indicator associated with it (with respect to the temperature in the processing chamber).

As indicated in FIG. 1, the device 1 preferably includes a housing 2 configured approximately as a standing cylinder, on whose upper end a feeder device 3 for introducing the graphite material GM is mounted, in particular a feeder device 3 for introducing graphic flakes GF.

In particular in the illustrated embodiment, the feeder device 3 is configured as a fall pipe, although it can also be arranged that the graphite material GM is fed in by way of an injection feeder.

The graphite material GM comes in contact with the rounding tools, which are also designated as so-called blades. Here the graphite flakes GF are folded and wound about a core of the individual graphite flake GF.

By means of this procedure, with use of the rounded graphite particles SG in a battery operation, a lower irreversible capacity and in addition a great lifetime is achieved. The smooth surface of the rounded graphite particles SG prevents flaking or twisting. The powder with the rounded graphite particles SG has an increased tamped density and thus in battery applications a greater energy density.

The powder is particularly suited for the production of lithium-ion batteries, because the lithium ions have a simplified access to the graphite through the hollow spaces between the rounded graphite particles SG; in particular the lithium ions accumulate in the spaces between the folded graphite flakes. The powder with the rounded graphite particles is again chemically cleansed and then layered after rounding and before use in battery production and the like.

The device 1 preferably comprises, as can be seen in FIG. 1, a number of rounding tools 5 situated on a rotor or, preferably, on a rotatably movable disk 7, in its processing chamber. The graphite material GM introduced into the device's interior space through the feeder device 3 is taken up by the rounding tools 5, accelerated and conducted against an impact surface 6, which is made up primarily of impact edges, which are inclined in relation to the inner lining surface of the housing.

The impact surface 6 constitutes, in particular, an area of the cylindrically configured inner lining surface 21 of the housing 2.

The rounding tools 5, according to FIG. 1 and FIG. 1A, in particular along the periphery and at regular distances from one another, are arranged on an outer circumference of a disk 7 that moves rotatably and is mounted by means of a first drive shaft 8 on a power drive that is not illustrated. The impact surface 6 and rounding tools 5 are configured so that the graphite material GM collides at different angles against the rounding tools 5, so that a particularly advantageous reshaping, especially a folding, of the graphite flakes GF can be obtained. The rounding tools 5 are optimized, in particular, for the highest possible number of particle collisions at various collision angles.

Processing of graphite material GM into spheroidized graphite SG occurs batchwise. The processing time per load depends not only, but mainly, on the capacity with which the rounding tools 5 can apply to the graphite material to be processed. The higher the capacity amount and thus the energy input per unit of time, the more strongly the contents of the processing chamber are warmed along with the processing chamber and its compartments. This leads to the problems mentioned at the outset.

In order to provide assistance to the extent possible, this embodiment is equipped with at least one additional connection per port 5a for feeding coolant into the interior of the processing chamber, preferably on its upper covering. Ideally, a second connection or port 5b is also provided. The latter contains an indicator for the processing space temperature. The aforementioned ports are clearly recognizable in FIG. 1B.

A coolant as a free cooling agent is introduced into the processing chamber through this port 5a. In the processing chamber it can mix with the graphite material GM that is to be rounded, and therefore particularly intensively and rapidly take up or absorb at least part of the energy introduced by the rounding tools 5 into the graphite material GM that is to be rounded (e.g., by coolant vaporization).

For the device 1 illustrated in FIGS. 1 and 1A, a temperature increase of about 130° C. occurs in the course of a batch processing without cooling.

If, on the other hand, an inventive water vapor coolant is used, absorbing air from the environment for this purpose at 15° C., which has a relative humidity of 65% and water content in the starting condition of about 8.9g/m³ , then a water quantity of 42 kg/h is sufficient to ensure a stable processing temperature between 60° C. and 70° C., because the median capacity input over the entire batch is about 50 kW.

Consequently, approximately 60% of the incorporated capacity must be cooled in order to obtain a stable operating level in the intended range. Accordingly, a coolant feeder in the inventive devices is configured so that 1 kg water per 1 kg of feeder product is conveyed into the processing chamber. More precisely, it can be estimated that feeders are to be aimed for in which between 0.5 kg and 1.5 kg of water per kg of feeder product is conveyed to the processing chamber.

The control variable in most cases, as in this embodiment, is the temperature in the processing chamber. If it reaches a level of 60° C., for instance, then initially the propellant of the dual liquid nozzles, preferably used here and also generally, is switched on. It consists, in this embodiment, of the dried compressed air. Ideally with time delay, primarily between 5 seconds and 30 seconds, the valve is then adjusted for the quantity of water used here. This injection quantity defines the cooling capacity.

FIG. 1B shows a particularly favorable assembly set-up for the port 5a. The coolant feeder is adjusted by about 90° in the rotation direction from the product outlet 17, of which the exhaust nozzle can be seen in FIG. 1B. The temperature gauge is ideally positioned directly opposite the coolant feed.

The coolant feed should not be situated too close to the aforementioned exhaust nozzle, to ensure that no dampened product is suctioned off.

For the situation depicted in FIG. 1B, the material moistened by the coolant feed must still travel for 270° around the site to reach the aforementioned exhaust nozzle. To assure for certain that the product emerges in dry condition from the installation, the coolant feed should be set up close to the exhaust device.

It can be seen from FIG. 1C that the radial position, at least for the port 5a to the coolant feed, is ideally situated radially outside the guide ring 41. Here the temperature of the graphite material as a rule is at its highest and there is only slight impact from the cold leaked air.

The device 1 further includes a separation device 10, for example an air sifter with classifier wheel 11.

In rounding the graphite flakes GF, abrasion can occur in the form of fine material and/or superfine material FM. Because the desired end product EP should preferably consist only of rounded graphite particles, the fine and superfine material FM is directly separated within the device 1 from the rounded graphite particles SG and removed from the device 1. The separation device 10 is positioned above the disk 7 with the rounding tools 5.

The classifier wheel 11 is connected by a second drive shaft (not shown in greater detail) having a second power drive, which likewise is not illustrated. In particular, it can be foreseen that the first drive shaft 8 and the second drive shaft are positioned coaxially.

By means of a feeder nozzle 14 in the lower area of the device 1, in particular under the rotating disk 7 with the rounding tools 5, process air PL is directed upward from below and from there conveyed onward to the rounding area and by means of the guide elements 25 to the separation device 10. The process air PL here carries off the fine material and/or superfine material FM, diverting it out of the device 1 by means of the suction nozzles 16.

Inside the device 1, the graphite material GM comes at least once into functioning contact with at least one rounding tool 5, so that a spinning motion is applied to the graphite material GM. By means of the guide elements 25, the graphite flakes GF set to spinning, the spinning, rounded graphite particles SG and the similarly spinning fine material and/or superfine material FM are diverted in a vertical direction, in particular perpendicular to the rotating disk 7, and thereby reach the separation device 10, for the most part at least, no longer spinning. This achieves an optimal flow toward the separation device 10, resulting in a high degree of classification precision.

According to one embodiment of the invention, the graphite material GM is inserted by the feeder device 3 into the processing chamber 40 of the device 1. The graphite material GM meets with the guide ring and thereby GM is conducted past the classifier wheel 11 so that the fine dust already present is sifted out.

The graphite material GM then encounters the disk 7 with the rounding tools 5, which deliver the energy for rounding. In particular, the graphite material GM is contacted by the disk 7 with the rounding tools 5, accelerated, and thrown against the impact surface 6. During these two first steps of the process, the product outlet 17 is kept closed.

The process air PL arrives by way of the feeder nozzles 14 at the housing 2 of the device 1 and flows through a gap 45 configured between the disk 7 with the rounding tools 5 and the impact surface 6.

In flowing through the gap 45, the impacted graphite particles are precisely directed to the classifier wheel 11 by the air volume stream 41. The material, which by now includes at least partly rounded graphite particles, proceeds in an internal flow back to the disk 7 with the rounding tools 5. The fine dust, in particular fine material and/or superfine material FM, departs from the device with the process air PL by way of the suction nozzles 16.

The rounded graphite particles SG are expelled by a suction device as shown in FIG. 1B. The suction occurs directly inside the guide ring 41. This ensures that no graphite material GM is withdrawn from the device 1 that has not first been conducted past the classifier wheel 11.

The graphite material GM is treated in the device for a definite period, wherein it comes, in particular repeatedly, into functional contact with the rotating rounding tools 5, so that the graphite flakes GF are folded and reshaped into rounded graphite particles SG. After a predefined period, it can be assumed that the graphite material GM by now consists largely of rounded graphite particles SG. The end product in the form of rounded graphite particles SG can now be removed from the device 1 by way of a product outlet 17 and put to use, for instance for the production of batteries.

For further improvement in the stressing of graphite material GM by improved streaming control, it is possible to arrange that a covering ring 18 is positioned in each case above the rounding tools 5, as seen in FIGS. 1 and 1A. The covering ring 18 extends advantageously over all rounding tools 5 arranged on the periphery of the rotating disk 7. It makes possible an advantageous circulation of the graphite particles that are to be rounded, because the directed streaming of the graphite particles inside the device 1 is optimized by means of the covering ring 18.

The covering ring, by narrowing the open surface in the area of the blades, creates a zone of very high energy density. The streaming speed of the circulating gas content increases strongly in this area by means of closing the channels between the blades. This facilitates the removal of the particles rejected by the sifter by means of the greater pressure gradients over the diameter of the disk 7 resulting from high speed.

This covering ring 18, in particular, prevents the rough graphite material GM, in particular the graphite flakes GF and/or already rounded graphite particles SG, from being thrown upward and circulating through the processing chamber 40 without contact with the rounding tools 5. The covering ring 18, in particular, imposes a multiple active contact between the rounding tools 5 and the rough graphite material GM.

According to one embodiment, the device 1, in addition, includes a control device (not illustrated) by means of which, for example, the first power drive and/or the second power drive and thus the rotation rate of the classifier wheel 11 and/or the rotation rate of the disk 7 with the rounding tools 5 are regulated and or controlled.

The German patent application with official file number DE 10 2023 122 651, appended to these documents upon their submission, describes a complete device with which, in several steps, rounded graphite of various classes can be produced with particular efficiency.

The entire device described by DE 10 2023 122 651 and the process also presented therewith, can be operated with particular efficiency if, at least in one and preferably all stages in which the use of a spheronizer is foreseen, a spheronizer is employed according to the standards of the present invention. Under these conditions, the entire disclosed content of the attached German application DE 10 2023 122 651 expressly becomes part of the application submitted today.

Accordingly, in the context of the present application, in due course not only, but also independently, protection can be claimed for a total device for producing spheroidized graphite which consists of a classifier mill and several devices, based on the standard of DE 10 2023 122 651, arranged in succession and supporting one another according to the claims made hereinafter in this application.

In addition, in due course, a process for producing spheroidized graphite in the following steps can be claimed: filling the processing chamber of a spheronizer built according to the standards of the current application, preferably according to the claims, in a batch made up of preferably pre-ground graphite, introduction of rotational energy into the processing chamber of the spheronizer, tempering of the processing chamber by introduction of a free coolant into the processing chamber. The tempering occurs preferably at a processing temperature between 40° C. and 120° C., ideally at a processing temperature between 40° C. and 100° C.

In addition, in due course protection can also be requested for a process for producing graphic particles of certain diverse classes of fineness by the effect of spinning, with the help of several successively installed spheronizers on the standard of the present patent application, wherein the graphite material that is to be rounded is pre-reduced and then an initial spheronizer, by folding, turns it to spheroidized graphite material of a first degree of fineness, which emerges from the process as an end product and simultaneously graphite material is separated out which for the most part cannot be processed to form graphite material of this first degree of fineness because it has been too far reduced, wherein the expelled, excessively reduced graphite material is directed to a second spheronizer, which, by folding, can produce from it a spheroidized graphite material of a second, finer degree of fineness likewise delivered by the process as an end product.

In addition, in due course, protection can be claimed for a process for producing rounded graphite particles of particular, varied degrees of fineness by spinning action, a process wherein the intensity of the pre-grinding or pre-reduction is adjusted in such a way that more than 50 weight % of the graphite material excluded by the spheronizer constructed by the standard of the present application can be extracted by its classifier wheel and then can be submitted to the second sifter likewise constructed by the standard of the present invention, which produces graphite material of a finer degree of fineness.

1. A device or spheronizer for rounding a graphite material by collision force, comprising a processing chamber, a feeder device for introducing graphite material into the processing chamber,
and a number of rounding tools, which—preferably—are arranged on the outer circumference of a rotor, preferably in the form of a disk, rotating about a rotation axis and in a rotation direction, which is situated in the processing chamber, wherein the rounding tools are configured in such a way that they can act on graphite particles during operation so that the latter become rounded by folding,
and a separation device to separate fine material and superfine material,
as well as a product outlet,
wherein
the processing chamber is equipped with a coolant feeder device by which the free cooling medium can be introduced into the processing chamber, wherein the device preferably also includes a regulator for the process space temperature.

2. The device according to claim 1, wherein the coolant feeder device includes at least one coolant atomizer or at least one coolant vaporizer which atomizes and/or vaporizes the coolant before and/or while it arrives in the processing chamber and before it wets or dampens the graphite particles.

3. The device according to claim 1, wherein the coolant feeder device includes at least one, preferably several dual liquid nozzles.

4. The device according to claim 1, wherein the coolant feeder device is fed with water and preferably also with air, ideally with dehumidified air.

5. The device according to claim 1, wherein the coolant feeder device dispenses a fluid vapor and preferably a water vapor, which it emits as a free cooling agent into the processing chamber.

6. The device according to claim 1, wherein the processing chamber is closed off by a cover and preferably by an upper-end cover and the coolant feeder device penetrates through the cover.

7. The device according to claim 6, wherein the coolant feeder device protrudes freely into the processing chamber through the environment that carries it, but preferably by less than 7.5 mm, better by less than 5 mm.

8. The device according to claim 1, wherein the coolant feeder device is subject to a—preferably regulated—coolant tempering device, which tempers the coolant before its introduction into the processing chamber in such a manner that in the processing chamber it does not go below its dewpoint.

9. The device according to claim 1, wherein the coolant is brought into the processing chamber having an excess pressure of at least one bar.

10. The device according to claim 1, wherein the coolant leaves the processing chamber by means of the separation device and/or by the product outlet.

11. The device according to claim 1, wherein the device possesses at least one gauge for the processing chamber temperature and this gauge preferably is positioned either at least a half processing chamber diameter away from the at least one coolant feeder device, particularly preferably in the cover and ideally on essentially the same radius as the coolant feeder device and then preferably at an angle of 90° to 270° to the coolant feeder device.

12. A total device for producing spheroidized graphite, comprising a classifier mill and several spheronizers arranged behind one another and interacting with one another, wherein the device or spheronizer for rounding a graphite material by collision force, including a processing chamber, a feeder device for introducing graphite material into the processing chamber,
and a number of rounding tools, which—preferably—are arranged on the outer circumference of a rotor, preferably in the form of a disk, rotating about a rotation axis and in a rotation direction, which is situated in the processing chamber, wherein the rounding tools are configured in such a way that they can act on graphite particles during operation so that the latter become rounded by folding,
and a separation device to separate fine material and superfine material,
as well as a product outlet,
wherein
the processing chamber is equipped with a coolant feeder device by which the free cooling medium can be introduced into the processing chamber, wherein the device preferably also includes a regulator for the process space temperature.

13. A process for producing spheroidized graphite, having the following steps:
filling the processing chamber of a spheronizer, wherein the device or spheronizer for rounding a graphite material by collision force, includes a processing chamber, a feeder device for introducing graphite material into the processing chamber,
and a number of rounding tools, rotating about a rotation axis and in a rotation direction, which is situated in the processing chamber, wherein the rounding tools are configured in such a way that they can act on graphite particles during operation so that the latter become rounded by folding,
and a separation device to separate fine material and superfine material,
as well as a product outlet,
wherein
the processing chamber is equipped with a coolant feeder device by which the free cooling medium can be introduced into the processing chamber, wherein the device preferably also includes a regulator for the process space temperature, with one batch made up of preferably pre-ground graphite,
introduction of rotational energy into the processing chamber of the spheronizer,
tempering the processing chamber by introducing a free coolant into the processing chamber, preferably at a processing temperature between 40° C. and 120° C., ideally at a processing temperature between 40° C. und 100° C.

14. A process for producing rounded graphite particles of certain varying classes of fineness through collision force,
with the help of several spheronizers situated in succession, wherein the spheronizer includes a processing chamber, a feeder device for introducing graphite material into the processing chamber,
and a number of rounding tools, which—preferably—are arranged on the outer circumference of a rotor, preferably in the form of a disk, rotating about a rotation axis and in a rotation direction, which is situated in the processing chamber, wherein the rounding tools are configured in such a way that they can act on graphite particles during operation so that the latter become rounded by folding,
and a separation device to separate fine material and superfine material,
as well as a product outlet,
wherein
the processing chamber is equipped with a coolant feeder device by which the free cooling medium can be introduced into the processing chamber, wherein the device preferably also includes a regulator for the process space temperature, wherein the graphite material to be rounded is pre-reduced and then from it an initial spheronizer, by folding, produces spheroidized graphite material of a first fineness class which is expelled as an end product upon conclusion of the process,
and simultaneously graphite material is expelled, which for the most part cannot be processed into graphite material of this first fineness class, because it has been excessively reduced,
wherein the expelled, excessively reduced graphite material is subjected to a second spheronizer, which by folding can produce therefrom spheroidized graphite material of a second, finer fineness class, which likewise is expelled as an end product upon conclusion of the process.

15. The process for producing rounded graphite particles of certain varying fineness classes by collision force, according to claim 14, wherein the intensity at which regrinding or reduction occurs is adjusted so that more than 50 weight % of the graphite material fed to the first spheronizer is issued by its classifier wheel and then can be submitted to the second spheronizer, which produces graphite material of a fine fineness class.

16. The process for producing rounded graphite particles of certain varying fineness classes by collision force, according to claim 14, wherein two spheronizers are arranged in succession, each of which issues an end product.

17. The process for producing rounded graphite particles of certain varying fineness classes by collision force, according to claim 14, wherein the fines (i.e., fine product) issued by the first spheronizer is fed to the second spheronizer without sifting it and/or filtering it again outside the first spheronizer.

18. The device according to claim 2, wherein the coolant feeder device includes at least one, preferably several dual liquid nozzles.

19. The device according to claim 2, wherein the coolant feeder device is fed with water and preferably also with air, ideally with dehumidified air.

20. The device according to claim 2, wherein the coolant feeder device dispenses a fluid vapor and preferably a water vapor, which it emits as a free cooling agent into the processing chamber.
